(19) United States
(12) Patent Application Publication
(10) Pub. No.: US 2002/0097798 A1
(43) Pub. Date: Jul. 25, 2002

(54) System and method for coding and decoding

(76) Inventor: Yehuda Manor, Jerusalem (IL)

Correspondence Address: Finnegan, Henderson, Farabow,, Garrett & Dunner, L.L.P., 1300 I Street, N.W., Washington, DC, 20005-3315, US

(21) Appl. No.: 09/908,461

(22) Filed: Jul. 19, 2001

Related U.S. Application Data
(60) Provisional application No. 60/249,270, filed on Nov. 17, 2000.

(51) Int. Cl. H04B 1/66

(52) U.S. Cl. 375/240.02

(57) ABSTRACT

Methods and systems are provided for integrating voice, video, and data. In particular, systems and methods for coding and decoding are provided. In one embodiment, the method encodes the signal. Moreover, the method includes receiving at least one of a plurality of quality of service measurements. Further, the method compresses the signal to produce a packet flow. In addition, the method varies compression based on at least one of the plurality of quality of service measurements, wherein an amount of information transferred by the packet flow varies to maintain a predetermined quality of service associated with the packet flow between the source of the packet flow and the destination of the packet flow.

### CROSS REFERENCE TO RELATED APPLICATION

This application claims the benefit of U.S. Provisional Patent Application No. 60/249,270, entitled “SYSTEM AND METHOD FOR INTEGRATING VOICE, VIDEO, AND DATA SERVICES,” filed on Nov. 17, 2000, the disclosure of which is expressly incorporated herein by reference in its entirety.

### BACKGROUND OF THE INVENTION

1. Field of Invention

The present invention relates generally to processing information. More particularly, the present invention relates to a method and apparatus for integrating voice, video, and data and relates to a method and system for coding and decoding.

2. Description of the Related Art

Digital Subscriber Line technology provides for the transport of digital information over telephone lines that actively carry voice such as plain-old-telephone system (POTS) voice or ISDN voice. Devices compliant with DSL technology, such as DSL modems and DSL access modems, transmit digital information at frequencies that are above the frequencies used for POTS voice. Various forms of DSL technology exist, and these forms are collectively referred to as “xDSL.” For example, POTS voice consists of an analog voice signal at less than 4000 Hertz. With xDSL, the xDSL modem or xDSL access modem transmits the digital information at frequencies above 4000 Hertz. Consequently, the digital information and the POTS voice are able to co-exist on the same cable used to provide POTS voice to a home or business.

The xDSL technologies include Integrated Services Digital Network DSL (IDSL), Symmetric (DSL), High-bit-rate DSL (HDSL), Second-generation HDSL (HDSL2), Single-pair High Speed DSL (S-HDSL), Asymmetric DSL (ADSL), and Very high bit-rate DSL (VDSL). Each of the xDSL signals has unique properties including, for example, data rate limitations and distance limitations. Table 1 below lists some of the signals included within the family of xDSL technologies.

TABLE 1
xDSL Technology Family

| | DOWN- | | |
|---|---|---|---|
| TECHNOLOGY | STREAM | UPSTREAM | DISTANCE |
| Integrated Services Digital | 128K | 128K | 18,000 ft |
| Network DSL (IDSL) | | | |
| Symmetric DSL (SDSL) | 2.3M | 2.3M | 12,000 ft |
| High-bit-rate DSL (HDSL) | 1.5M | 1.5M | 15,000 ft |
| Second-generation HDSL | 1.5M | 1.5M | 15,000 ft |
| (HDSL-2) | | | |
| Single-pair High Speed DSL | 2.3M | 2.3M | 12,000 ft |
| (S-HDSL) (SHDSL) | | | |
| Asymmetric DSL (ADSL) | 1.5-6M | 256-640K | 18,000 ft |
| Very high bit-rate DSL (VDSL) | 26M | 3M | 4,500 ft |
| | 22M | 3M | 4,500 ft |
| | 13M | 13M | 4,500 ft |

However, xDSL is only one way of providing a destination with information. Today, a typical destination, such as a residence or business may have separate communications lines and/or connections for voice and xDSL, cable television, Internet access, direct broadcast television, and digital cable. For example, a destination, such as a residence may include an xDSL modem for voice and Internet access, a cable TV modem for digital or analog television, a facsimile modem for exchanging facsimiles, and/or a radio frequency (RF) transceiver and modem for accepting RF information, such as direct broadcast television or Internet access. Accordingly, each of these connections and corresponding communications equipment, such as modems provides information using different protocols, devices, and/or media. As a result, a user receiving information from the various connections may be required to support a wide variety of protocols, devices, and media, burdening the user.

### SUMMARY OF THE INVENTION

Accordingly, the present invention is directed to devices and methods for integrating voice, video, and data and, in particular, to devices and methods for coding and decoding. It is an object of the present invention to overcome one or more problems associated with past approaches. Additional objects and advantages of the invention will be set forth in part in the description which follows, and in part will be understood from the description, or may be learned by practice of the invention. The objects and advantages of the invention will be realized and attained by means of the elements and combinations particularly pointed out in the appended claims.

To achieve these and other advantages and in accordance with the purpose of the invention, as embodied and broadly described herein, there is provided a method for encoding a signal including, for example, encoding the signal; receiving at least one of a plurality of quality of service measurements; compressing the signal to produce a packet flow; and varying said compressing step based on at least one of the plurality of quality of service measurements, wherein an amount of information transferred by the packet flow varies to maintain a predetermined quality of service associated with the packet flow between the source of the packet flow and the destination of the packet flow.

Further, in another embodiment, there is provided a system for encoding a signal. The system including means for encoding the signal; means for receiving at least one of a plurality of quality of service measurements; means for compressing the signal to produce a packet flow; and means for varying said means for compressing based on at least one of the plurality of quality of service measurements, wherein an amount of information transferred by the packet flow varies to maintain a predetermined quality of service associated with the packet flow between the source of the packet flow and the destination of the packet flow.

Moreover, in still yet another embodiment, there is provided a system for processing a plurality of packets that include one or more of video, voice, and data information using a plain-old-telephone system. The system including, for example, code that receives one or more packets from a source of packets, code that decodes the one or more packets when the one or more packet are encoded by the source, code that decompresses the one or more packets into a stream of bits when the one or more packets are compressed by the source, code that monitors at least one of a plurality of quality of service measurements associated with transmission of the one or more packets, and code that sends the source of the one of more packets the at least one of a plurality of quality of service measurements, wherein the source can vary an amount of information transferred by the one or more packets based on the at least one of a plurality of quality of service measurements; and at least one processor that executes said code.

In addition, in another embodiment, there is provided a system for encoding a signal. The system including, for example, at least one memory including code comprising code that encodes the signal, code that receives at least one of a plurality of quality of service measurements, code that compresses the signal to produce a packet flow, and code that varies said code that compresses based on at least one of the plurality of quality of service measurements, wherein an amount of information transferred by the packet flow varies to maintain a predetermined quality of service associated with the packet flow between the source of the packet flow and the destination of the packet flow; and at least one processor that executes said code.

Further, in another embodiment, there is provided a method for decoding a signal. The method including decoding the signal; receiving at least one of a plurality of quality of service measurements; decompressing the signal to produce an information flow; and varying said decompressing step based on at least one of the plurality of quality of service measurements, wherein an amount of information transferred by the information flow varies to maintain a predetermined quality of service associated with the information flow between the source of the information flow and the destination of the information flow.

Moreover, in still another embodiment, there is provided a system for decoding a signal. The system including code that decodes the signal, code that receives at least one of a plurality of quality of service measurements, code that decompresses the signal to produce an information flow, and code that varies said decompressing based on at least one of the plurality of quality of service measurements, wherein an amount of information transferred by the information flow varies to maintain a predetermined quality of service associated with the information flow between the source of the information flow and the destination of the information flow; and at least one processor that executes said code.

In yet another embodiment, there is provided a system for decoding a signal. The system including means for decoding the signal; means for receiving at least one of a plurality of quality of service measurements; means for decompressing the signal to produce an information flow; and means for varying said decompressing based on at least one of the plurality of quality of service measurements, wherein an amount of information transferred by the information flow varies to maintain a predetermined quality of service associated with the information flow between the source of the information flow and the destination of the information flow.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate an embodiment of the invention and, together with the description, serve to explain the objects, advantages, and principles of the invention. In the drawings,

FIG. 1 illustrates, in general block diagram form, an exemplary network consistent with the systems and methods of the present invention;

FIG. 2 illustrates, in general block diagram form, an access device consistent with the systems and methods of the present invention;

FIG. 3 illustrates, in general block diagram form, a CPE device consistent with the systems and methods of the present invention;

FIG. 4 illustrates, in general block diagram form, an exemplary access device consistent with the systems and methods of the present invention;

FIG. 5 illustrates, in general block diagram form, an exemplary CPE device consistent with the systems and methods of the present invention;

FIG. 6 illustrates, in general block diagram form, an exemplary video encoder consistent with the systems and methods of the present invention;

FIG. 7 illustrates a flow chart with exemplary steps for encoding video information consistent with the systems and methods of the present invention;

FIG. 8 illustrates, in general block diagram form, an exemplary video decoder device consistent with the systems and methods of the present invention;

FIG. 9 illustrates a flow chart with exemplary steps for decoding video information consistent with the systems and methods of the present invention;

FIG. 10 illustrates, in general block diagram form, another exemplary CPE device consistent with the systems and methods of the present invention; and

FIG. 11 illustrates, in general block diagram form, another exemplary network consistent with the systems and methods of the present invention.

### DESCRIPTION OF THE PREFERRED EMBODIMENTS

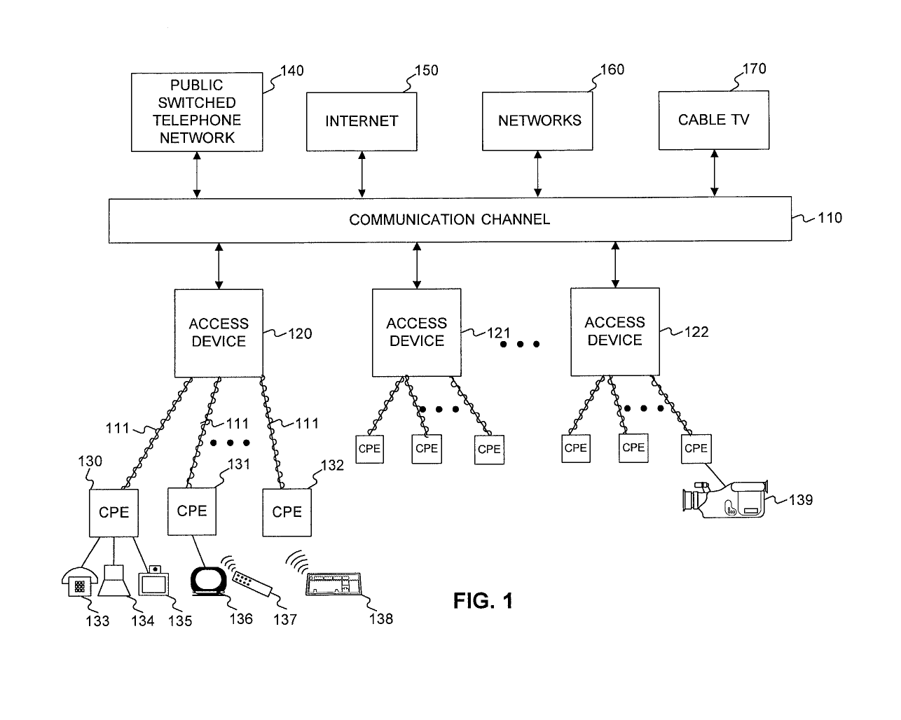

FIG. 1 shows an exemplary network for providing integrated voice, video, and data services consistent with the systems and methods of the present invention. FIG. 1 includes one or more access devices 120-122 connected through a communication channel 110 to the Public Switched Telephone Network (PSTN) 140 and one or more sources of information, such as the Internet 150, a cable television network 170, and/or any other networks 160. Moreover, the one or more sources of information may also include a digital head-end, a video-on-demand server, a video server, and/or a pay-per-view server. The one or more access devices 120-122 may also connect through wiring, such as the twisted-pair cables commonly used in the PSTN or coaxial cable as used in cable networks.

In one embodiment, the one or more access devices 120-122 may connect to each of the CPE devices 130-132 through the twisted-pair cables 111 of the PSTN, such as the twisted-pair of the plain-old-telephone system. Each of the CPE devices 130-132 may connect, for example, to one or more of the following: a telephone 133, a computer 134, a video conferencing system 135, a television 136, an infrared remote controller 137, an infrared keyboard 138, and an audiovisual source 139, such as a camcorder.

The information flows (i.e., of voice, video, and data) between each CPE device 130-132 and the one or more sources of information 150-170 may be unidirectional or bi-directional. Moreover, the access devices 120-122, the CPE devices 130-132, and the subsystems therein may function in a bi-directional manner, permitting a bi-directional flow of information (i.e., transmit and receive) with the one or more sources of information 150-170 and/or the PSTN 140. Alternatively, the access devices 120-122, the CPE devices 130-132, and the subsystems therein may function in a unidirectional manner.

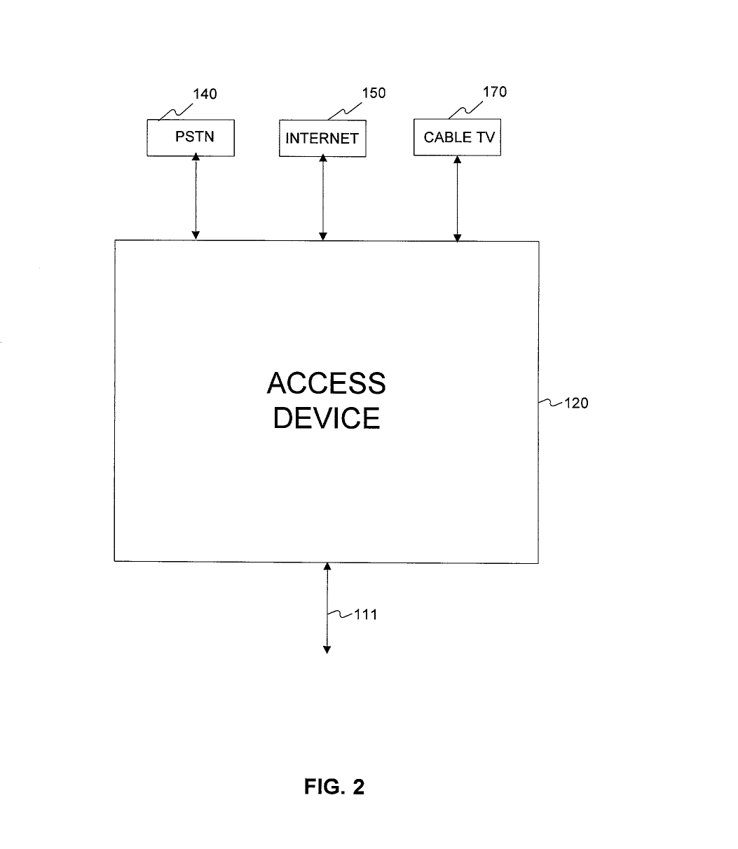

FIG. 2 shows exemplary inputs and outputs for an access device consistent with the systems and methods of the present invention. Referring to FIG. 2, the access device 120 may interface with the PSTN 140, the Internet 150, and a source of cable television 170. The access device 120 may integrate one or more sources of information and provide integrated information to the CPE device 130 over an existing PSTN connection, such as a twisted-pair copper wire that connects a telephone central office to a home, business, or other destination. The access device 120 may be placed in one or more central offices that provide access to the PSTN 140 and to a twisted-pair for each destination. Moreover, the central office may include locations, such as a telephone closet, a communication center, a basement of a building, and/or a network operations center, without departing from the spirit of the present invention. In one embodiment, the central office that includes the access device 120 may be a telephone central office that services an area, such as a neighborhood and interfaces to the PSTN 140 and to the one or more sources of information 150-170. Alternatively, the central office that includes the access device 120 may be a point of entry into a network, such as a local area network, campus network, metropolitan network, or wide area network.

The access device 120 may process the one or more sources of information 150-170 by integrating the information into a common protocol, such as the Internet Protocol (IP); modulating the IP-based information using a coder-decoder (codec), such as a Digital Subscriber Line (DSL) codec that places the IP-based information at frequencies above the highest frequency of a voice signal on the PSTN; and/or providing error-correction and detection prior to transmitting the IP-based information to the one or more CPE devices 130-132 through twisted-pair cables or wires 111.

For example, the access device 120 may receive a voice signal from the PSTN 140 and information from the one or more sources of information 150-170, such as the Internet access 150 and/or cable television 170. The access device 120 may integrate the one or more sources of information, such as the Internet access 150 and cable television 170 into a common protocol, such as the Internet Protocol (IP), asynchronous transfer mode (ATM), and/or any other communications protocol. In one embodiment, the Internet access 150 and cable television 170 may be formatted into a flow of packets using the Internet Protocol (IP). The access device 120 may then modulate the IP-based information using a coder-decoder (codec), such as a Digital Subscriber Line (DSL) codec that places the IP-based information at frequencies above the highest frequency of the voice signal. The access device 120 may also provide forward error-correction (FEC) and detection; combine the modulated IP-based information with the voice signal; and then transmit the modulated IP-based information and the voice signal to one or more CPE devices 130-132 through twisted-pair wires 111.

Referring again to FIG. 1, the CPE device 130 may receive a signal containing the voice signal and the modulated IP-based information and then separate the voice signal from the modulated IP-based information. The voice signal may then be provided to a telephone 133. A codec, such as a DSL codec within the CPE device 130 may also demodulate the modulated IP-based information and provide a baseband signal, such as an Ethernet signal containing the IP-based information. The CPE 130 may then transport the IP-based information to an output port.

Moreover, IP-based information may be further processed based on the type of IP-based information. For example, IP-based information corresponding to a flow of video or audio may be further processed into information compatible with a receiver of the video or audio information, such as a television 136 or video teleconferencing terminal 135. In one embodiment, when the IP-based information includes video, the packets associated with the IP-based information may be routed to other processors, such as a video coder/decoder, an error correction detection module, and/or other hardware, software, or firmware that processes the IP packets into a format suitable for the receiver (e.g., television 136) connected to the CPE device 130.

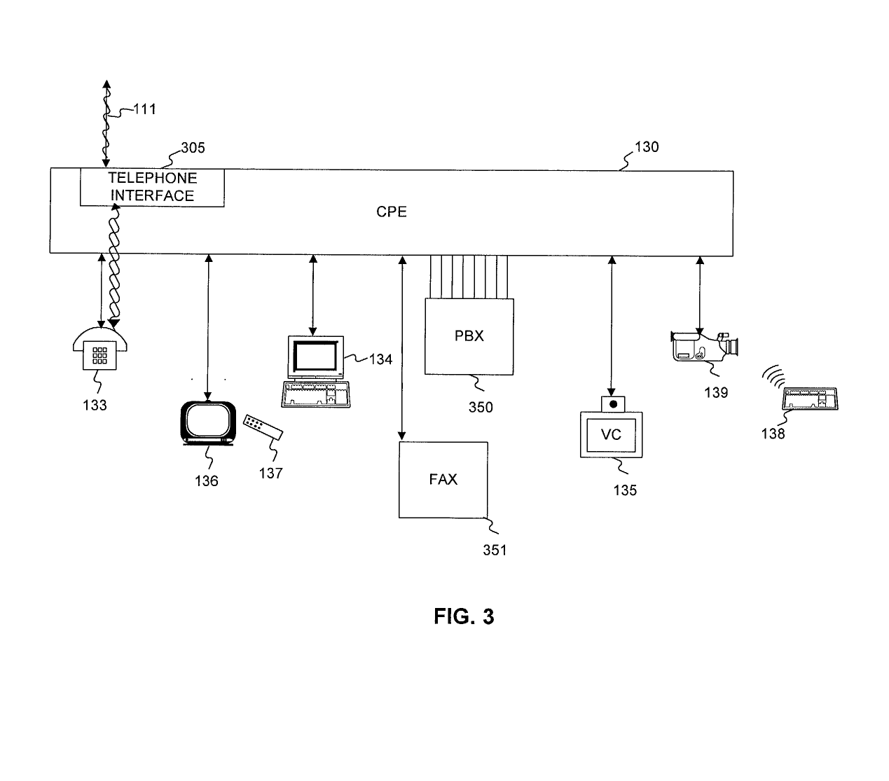

FIG. 3 shows exemplary inputs and outputs for a CPE device 130 consistent with the systems and methods of the present invention. Referring to FIG. 3, the CPE device 130 may receive from a twisted-pair 111 of the PSTN at a telephone interface 305 a signal including a voice signal, such as a plain-old-telephone-system (POTS) voice signal and a modulated signal. Although other modulated signals may be received, in one embodiment, the modulated signal is an xDSL (e.g., a VDSL signal) signal including IP-based information. The CPE device 120 may separate the voice signal from the xDSL signal by, for example, filtering the voice signal using a filter, such as a low pass filter. The CPE device 120 may then provide the voice signal to the telephone 133.

The modulated signal may be demodulated or decoded to yield an Ethernet signal containing IP packets. For example, if the modulated signal is an xDSL signal, such as a Very High Speed DSL (VDSL) modulated signal, the CPE device 130 may decode the VDSL signal to yield a baseband signal, such as Ethernet encapsulating IP packets. The IP packets may include information from the one or more sources of information 150-170.

Moreover, the CPE device 130 may also process the IP packets based on the type and destination of each packet. For example, IP packets from the Internet containing information, such as e-mail or Internet access may be switched directly to a port on the CPE device 130 supporting a computer 134. Moreover, IP packets containing a video and/or audio information may be further processed with a video codec, a forward error detection and correction module, a quality of service module, and/or other modules that process the IP packets into a format suitable for a device connected to the CPE device 130, such as a television 136, computer 134, and/or video teleconference system 135. Furthermore, the CPE device 130 may perform additional processing including, for example, a public branch exchange (PBX) service between the CPE device 130 and the one or more access devices 120-122, a facsimile service for providing facsimiles, a voice over IP service, and/or a time division multiplexing (TDM) over IP service that permits TDM traffic, such as a T1 to be transported between the CPE device 130 and the one or more access devices 120-122. This additional processing will be further described below.

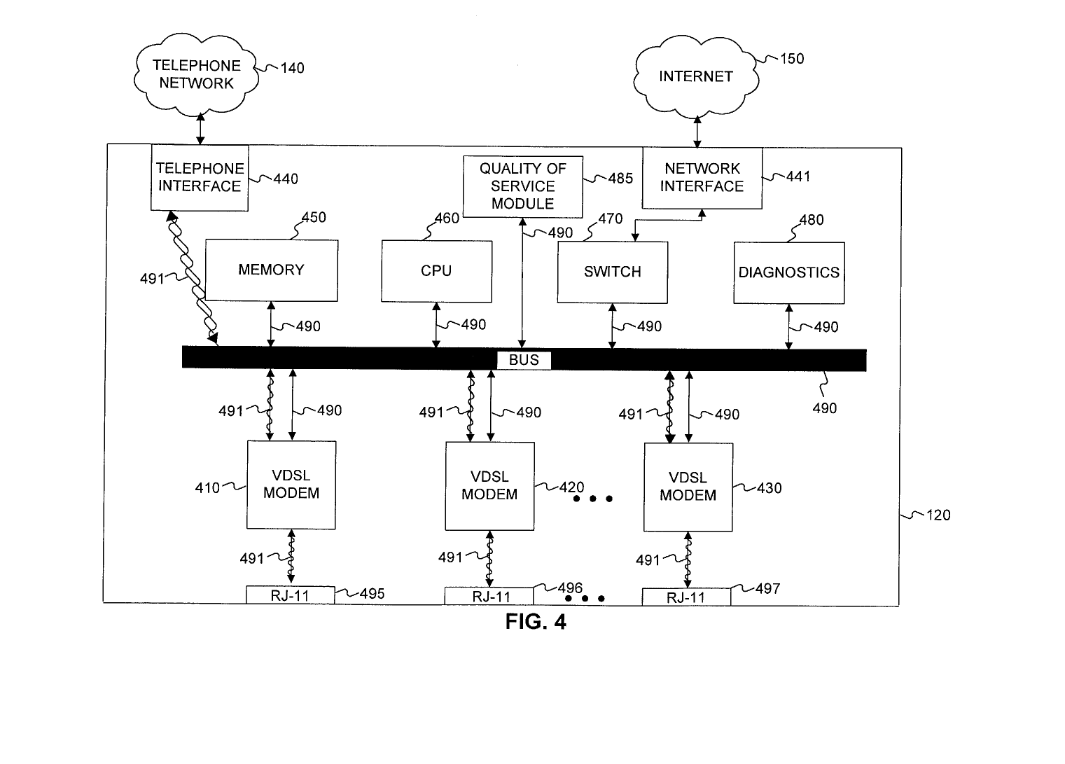

FIG. 4 shows an exemplary block diagram of an access device consistent with the methods and systems of the present invention. Referring to FIG. 4, the access device 120 may include a telephone interface 440, a network interface 441, a memory 450, a central processing unit (CPU) 460, a switch 470, a quality of service module 485, a diagnostics module 480, one or more VDSL modems 410-430, a bus 490 with connections to each of the modules, or subsystems, of the access device 120, one or more twisted pair connections 491, and one or more output interfaces, such as RJ-11 jacks 495-497. In one embodiment, the quality of service module 485 may be incorporated within the switch 470 and/or the CPU 460.

The telephone interface 440 may include a call control that supports interfacing with the PSTN 140. The call control may support establishing calls with functions such as on/off hook, ringing, and dual tone multi-frequency (DTMF). Furthermore, the call control within the telephone interface 440 may support setting-up and tearing-down one or more calls using switching and signaling protocols such as, Q.931, GR-303, and Signaling System 7 (SS7) protocol for controlling call establishment through one or more telephone central offices.

The network interface 441 may include a network interface card that exchanges packets, such as IP packets with a network, such as the Internet 150 and forwards the IP packets to the switch 470.

The switch 470 may transport incoming information to the appropriate module within the access device 120. For example, the switch 470 may route IP packets to a CPE device through the bus 490, the VDSL modem 410, and the RJ-11 port 495. Although FIG. 4 shows a bus 490, the bus 490 may include one or more busses providing a plurality of separate connections. For example, the bus 490 may provide a separate connection for plain-old-telephone voice signals, a separate connection for audiovisual information provided from a source of digital audiovisual information, and still another connection for information, such as Internet data. In one embodiment, the switch 470 may directly connect to the VDSL modem using the Serial Media Independent Interface (SMII) permitting a direct Ethernet connection that bypasses the bus 490.

The quality of service module 485 may monitor and/or measure the quality of service between the access device 120 and each of the CPE devices (e.g., CPE devices 130-132) served by the access device 120. In one embodiment, the quality of service module 485 may monitor and/or measure one or more of the following: availability of a communication path between the access device 120 and each of the CPE devices 130-132; throughput between the access device 120 and each of the CPE devices 130-132; packet loss between the access device 120 and each of the CPE devices 130-132; latency between the access device 120 and each of the CPE devices 130-132; jitter associated with packets transported between the access device 120 and each of the CPE devices 130-132; and any other aspect of the communication between the access device 120 and the CPE device to provide an indication of the quality of the communication.

In one embodiment, the quality of service module 485 may enable quality of service between the CPE device 130 and the access device 120, the access device 120 and the communication channel 110, such as the Internet 150, and the communication channel 110 and the one or more sources of the information 150-170, such as the digital head-end of a video-on-demand system connected to the Internet 150. For example, the CPE device 130 may exchange quality of service parameters with the access device 120. The access device 120 may then request a quality of service from the one or more sources of information 150-170 through the communication channel 110 based on the quality of service parameters received from the CPE device 130. Moreover, the one or more sources of information 150-170 may also include one or more CPE devices and/or access devices. Moreover, the switch 470 may also include a quality of service module 485.

Availability provides an indication of the availability of a connection between the access device 120 and each of the CPE devices 130-132. Throughput provides a measurement of an amount corresponding to the total amount of data that is exchanged between the access device 120 and each of the CPE devices 130-132. Packet loss provides a measurement that counts the number of lost packets within a predetermined time, such as 5 minutes. Latency represents the travel time for a packet traveling between the access device 120 and any one of the CPE devices 130-132. Jitter corresponds to variations in timing when a packet travels between the access device 120 and any one of the CPE devices 130-132. Other quality of service measurements may also be monitored and/or measured.

In one embodiment, when a quality of service threshold is reached, the quality of service module 485 may provide an indication to other processors (e.g., at an access device or CPE device) to improve the quality of service. For example, the quality of service module 485 may provide a video codec for a source of video information with quality of service measurements such that the video codec varies coding based on the quality of service measurements. The video codec may thus adapt coding and/or decoding based on the received quality of service measurements by varying the amount of information transferred, such as by varying the effective bit rate for the codec, varying a coder type (e.g., changing from 8-bit PCM voice to Code Excited Linear Predictive Coding (CELP)) for the codec, varying the compression ratio, and/or varying any other parameter associated with the codec. The source of the information may also vary the amount of information by varying the balance between payload and overhead information used for error correction and/or by varying the type of communication protocol used for transmission (e.g., changing from UDP/IP to TCP/IP). This approach of adapting (i.e., varying the amount of information) based on the measured quality of service measurements will be further described in detail below.

In one embodiment, one or more control paths may be established between the source of the information, the access device, and/or the CPE device. The control path may also be used to provide the source of the information with quality of service measurements such that the source may vary the amount of information (e.g., changing the balance between the payload and overhead for error correction).

Moreover, the control path may be routed with the information flow or, alternatively, separate from the information flow. In one embodiment, when the flow of information includes audiovisual information, such as television information, the control path may use a separate route from the audiovisual information flow and may be provisioned with a protocol and/or quality of service that differs from the audiovisual information flow. For example, the audiovisual information flow may be transmitted or received using a user datagram protocol (UDP) connection between the source of the information and the CPE device. On the other hand, the control path between the source of the information and the CPE device may use a TCP connection.

The diagnostics module 480 may monitor the status of the access device 120. For example, the diagnostics module 480 may check on the health and status of each the processors and/or modules (see, e.g., 410-497 at FIG. 4) within the access device 400 and report the health and status of each of the processors or modules therein to another processor, a user, and/or a network services provider. For example, the diagnostics module 480 may check each of the processors or module within the access device 120 and verify operation (i.e., powered on and operating without malfunctions); communicate with a CPE device (not shown) and verify that the CPE device is also functioning properly; may configure and/or modify each of the modules or processors within the access device 120 to eliminate the need for a technician to be co-located with the access device 120 when configuring the access device 120; and/or may configure and/or modify each of the modules or processors within the CPE device (not shown) to eliminate the need for a technician to be co-located with the CPE device when configuring the CPE device for operation.

The CPU 460 may control the processors and modules within the access device 120. Moreover, the CPU 460 may control and configure one or more VDSL modems 410-430 by providing configuration information to each of the VDSL modems 410-430.

The memory 450 may include storage that supports the access device 120, such as the modules and/or processors of the access device 120. For example, the memory 450 may store program code and/or information for the access device 120. In one embodiment, the memory 450 stored the program code and information for booting up and configuring the access device 120 for operation.

The xDSL modems 410-430 may include any of the various forms of xDigital Subscriber Line (DSL) modems such as Integrated Services Digital Network DSL (IDSL), Symmetric (DSL), High-bit-rate DSL (HDSL), Second-generation HDSL (HDSL2), Single-pair High Speed DSL (S-HDSL), Asymmetric DSL (ADSL), and Very high bit-rate DSL (VDSL). Although VDSL modems are shown in FIG. 4, other modems may be used instead.

The one or more output interfaces 495-497, such as RJ-11 jacks may connect the access device 120 with one or more CPE devices (not shown) through a connection, such as a twisted-pair copper wire that is commonly used in the PSTN 140 to connect a central office to one or more destinations (e.g., homes or businesses).

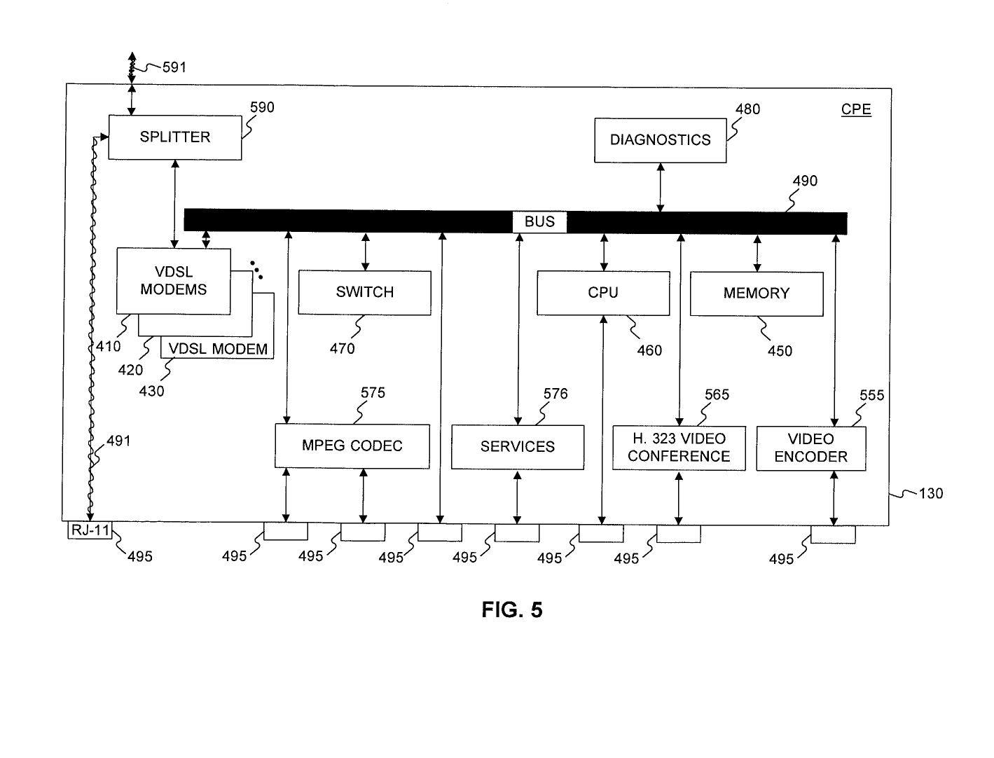

FIG. 5 shows an exemplary block diagram for the CPE device 120 consistent with the methods and systems of the present invention. Referring to FIG. 5, FIG. 5 may include a splitter 590, a diagnostics module 480, one or more VDSL modems 410-430, a switch 470, one or more MPEG codecs 575, a CPU 460, a memory 450, a video conferencing module 565, a video encoder 555, a services module 576, a bus 490, a twisted-pair cable 491, and one or more ports 495, such as an RJ-11 jack for connecting to one or more systems (e.g., a telephone 133, a television 136, a computer 134, a video conferencing system 135, a camcorder 139, etc.). Although FIG. 5 shows a bus 490, one or more separate connections may be used instead. For example, the video conferencing module 565, the video encoder 555, the services module 576, and the MPEG codec 575 may each be directly connected to the switch 470 using a SMII interface and thus bypassing the bus 490.

The splitter 590 may separate a voice signal, such as a POTS voice signal from a signal modulated by a VDSL modem. In one embodiment, a low pass filter filters the POTS voice signal permitting the voice signal to pass to a telephone (e.g., the telephone 133) through the RJ-11 jack 495.

The Moving Picture Experts Group (MPEG) codec 575 may be embodied in a variety of devices to permit the decoding of audiovisual information compressed in one of the MPEG compatible formats. Moreover, although an MPEG codes is used in the embodiment of FIG. 5, other audiovisual codecs may be used instead. The MPEG codec 575 will be described in further detail below.

The video encoder 555 may be implemented with a variety of devices that permit encoding a source of video. In one embodiment, the video encoder 555 included an MPEG coder/decoder. Alternatively, the video encoder 555 may only include an MPEG encoder. For example, the video encoder 555 may process a source of video, such as analog or digital video; compress the video; add error correction to the compressed video; and then encapsulate the video within packets. The video encoder 555 may also similarly process audio information to produce packets.

MPEG includes a family of standards that code audio-visual information, such as video, audio, music, and movies by compressing the audiovisual information in a predetermined format. The MPEG family of standards includes the MPEG-n series of standards, such as MPEG-1, MPEG-2, MPEG-4, MPEG-7, and MPEG-21. One of the common features associated with the MPEG-n series is that MPEG-n based compression uses spatial (i.e., within a frame or scene) and temporal (i.e., between frames and scenes) approaches to compress the audio and visual information. Although MPEG-n based compression is described herein, any other codec may be used including, for example, a wavelet compression based codes, a discrete cosine transform based codec, and/or a Fourier transform based codec.

The H.323 videoconference module may process audiovisual information in a manner compatible with International Telecommunication Union (ITU) standard H.323 available from the ITU. The H.323 standard includes definitions for transporting audiovisual information associated with a teleconference across a network, such as the PSTN 140, the Internet 150, and/or any other network capable of transporting a teleconference based on the H.323 standard. Although the embodiment of FIG. 5 implements an H.323 compatible teleconference, other approaches to teleconferencing may be used instead.

In one embodiment, the CPU 460 may include a pattern generator that generates digital images. These generated images are provided to video encoder 555 or MPEG codec 575. The video encoder 555 or MPEG codec 575 may then receive the generated images and then output images for analysis by the CPU 460. The CPU 460 may also compare the output images with images stored in the memory 450 to assess the operation of the video encoder 555 or MPEG codec 575. For example, if the output images differ from the stored images, the CPU 460 may determine that the video encoder 555 may not be functioning properly. In one embodiment, the CPU 460 may produce images during boot-up and/or during idle periods to periodically assess the operation of the video encoder 555 or MPEG codec 575. Furthermore, the CPU 460 may provide the results of its analysis to other processors and/or a network management center (not shown) for further assessment and/or corrective action, such as reconfiguring or replacing the video encoder 555 or MPEG codec 575.

The services module 576 may provide a variety of services including, for example, a voice over IP service, a PBX service, a facsimile service, and/or a TDM over IP service.

In one embodiment, the services module 576 may include a voice over IP module that accepts audio information provided to the CPE device 120. For example, a user of the computer 134 may use the computer 134 to provide audio information to the CPE device 120 for transport over the Internet. When the services module 576 receives the audio information, the services module may encode the audio information using a voice codec for encoding voice; and then encapsulate the encoded voice signal in IP packets for transmission over a network, such as the Internet 150. Accordingly, the voice over IP service permits a user of the CPE device 120 to communicate with other users through a network, such as the Internet 150.

In one embodiment, the services module 576 included a PBX service for accepting one or more pulse code modulation (PCM) signals, such as the PCM signals provided by a PBX. A PCM signal may include a pulse code modulated signal that is sampled at 8000 samples per second such that each sample is represented by 8-bits. In one embodiment, the PCM signal may be based on ITU G.707. The one or more PCM signals may also form one or more voice channels at 56 kilobits per second or 64 kilobits per second (also referred to as a DS0).

Moreover, the PBX service of the services module 576 may encapsulate the PCM signal using one or more IP packets, support a switching and signaling protocol, and transmit the IP-based PCM signal to the access device (not shown) through the bus 490, switch 470, VDSL modem 410, and splitter 590. At the access device (e.g., the access device 120 of FIG. 1), a corresponding PBX services module (not shown) may remove the IP header from each packet and provide the PSTN 140 with one or more voice channels and associated switching and signaling protocol.

The services module 576 may also include a TDM service to encapsulate a time division multiplexed (TDM) signal using one or more IP packets, and transmit the IP-based TDM signal, such as a Ti signal, to the access device (not shown) through the bus 490, switch 470, VDSL modem 410, and splitter 590. At the access device (e.g., the access device 120 of FIG. 1), a corresponding TDM service module (not shown) may remove the IP header from each packet and provide the TDM signal to a network, such as the PSTN 140 and/or the Internet 150.

The facsimile service provided by the services module 576 may detect an incoming facsimile signal. For example, when the CPE device 130 receives a facsimile included within the POTS voice signal, the facsimile service may detect the facsimile signal within the POTS voice signal, decode the facsimile signal, and provide an output to the user through the output interface 595.

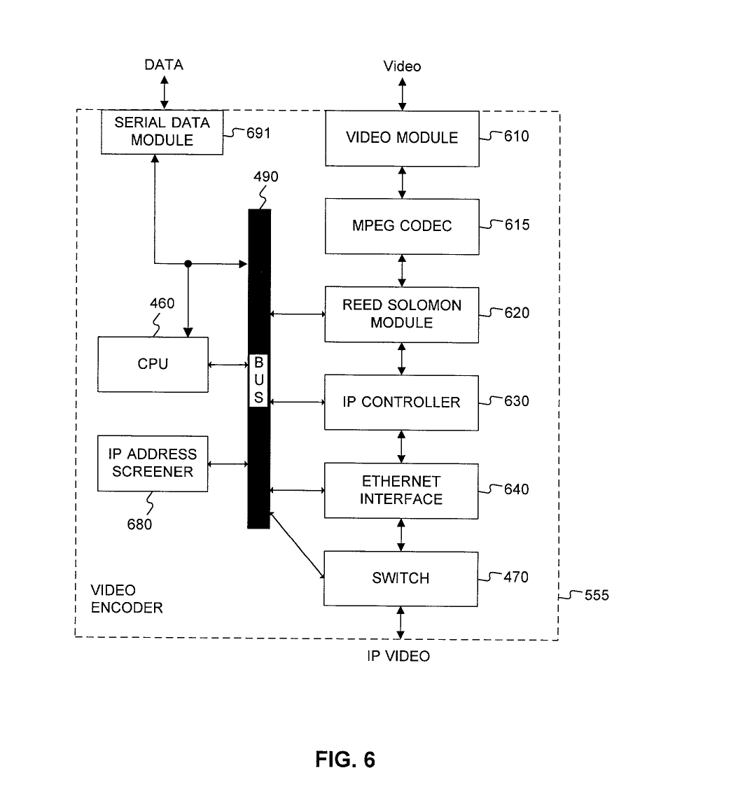

FIG. 6 shows an exemplary block diagram for a video encoder 555 consistent with the systems and methods of the present invention. Referring to FIG. 6, the video encoder 555 may include a video module 610, an MPEG codec 615, a Reed Solomon error correction and detection module 620, an IP controller 630, an Ethernet interface 640, a switch 470, a bus 490, a serial data module 691, a CPU 460, and an IP address screener 680. Although FIG. 6 shows a serial data module 691, a parallel data module may be used instead.

Referring again to FIG. 5, a video source, such as a camcorder, may connect to one of the ports 495 of the CPE device 120. The video information from the camcorder enters the video encoder 555 for processing. Referring again to FIG. 6, the video information enters the video module 610 for initial processing, such as amplification, and if necessary, digital-to-analog conversion.

The MPEG codec 615 encodes the digital video by compressing the digital video based on an MPEG-n format. The MPEG codec 615 may then format the digital video by assembling the digital video information into one or more blocks, such as 8 pixel by 8 pixel blocks and into a frame that includes a scene composed of the one or more blocks. The MPEG codec 615 may perform spatial and temporal processing of the assembled digital video enabling compression of the assembled digital video using one of the MPEG-n series of compression formats, such as MPEG-4. Although an MPEG codec 615 is shown in FIG. 6, any other type of codec may be used instead.

In one embodiment, the MPEG codec 615 may be programmable by the CPU 460 such that various parameters may be programmed into the MPEG codec 615 to configure the MPEG codec 615. These various parameters may vary the amount of information contained in the output of the MPEG codec by, for example, varying the calculation of each of the image vectors associated with the MPEG algorithm (e.g., the calculation of an extrapolated image vector (B) based on the initial image vector (I) and the motion vector (P)), a size for each block within a frame, a bits per second output at the MPEG code, a number corresponding to the quantity of B frames computed, an indicator for placing the I vectors, an indicator corresponding to whether to engage or disengage scene or frame learning, a packet length, one or more filter parameters associated with the MPEG codec, such as the input filter parameters (e.g., median filter, sharpness filter, temporal filtering parameters, and Infinite Impulse Response (IIR) filter parameters), one or more parameters for varying motion estimation, and one or more parameters to set the number of quantization bits.

In one embodiment, the information contained in the output of the MPEG codec is varied based on one or more quality of service measurements. For example, when packet loss between the access device and the CPE device exceeds a predetermined threshold, a larger compression ratio may be implemented by the MPEG codec 615. The larger compression ratio may enable an improved bit error rate between the access device and the CPE device, which may improve quality of service (e.g., fewer lost packets).

To provide error detection and correction, a Reed Solomon module 620 may provide forward error correction (FEC) and detection. The Reed Solomon module 620 may process the received compressed video received from the MPEG codec 615 and further encode the compressed video by providing Reed Solomon FEC. In one embodiment, the Reed Solomon module may be implemented using an application specific integrated circuit (ASIC), Reed Solomon Encoder/Decoder, such as the Reed Solomon Encoder/Decoder ASIC available from Texas Instruments. Although Reed Solomon encoding is used to provide error correction and detection, any other forward error correction and detection techniques may be used instead.

Moreover, in one embodiment, the CPU 460 may configure the Reed-Solomon module 620 and vary the configuration based on the quality of service. For example, the run length (i.e., the ration of error correction overhead to information) of the encoding may be varied based on the quality of service.

The IP controller 620 may include a processor capable of encapsulating the video provided by the Reed Solomon module 620 into packets, such as IP packets.

The Ethernet interface 640 may receive IP packets from the IP controller and encapsulate the IP packets within Ethernet packets or frames. The Ethernet interface 640 may then provide the Ethernet encapsulated IP packets to an access device (not shown) through the switch 470, the bus 490, a VDSL modem (e.g., the VDSL modem 410 of FIG. 5), a splitter (e.g., the splitter 590 of FIG. 5), and twisted-pair cables (e.g., the twisted-pair cables 591 of FIG. 5).

The IP address screener 680 may perform screening of IP packets to ensure that the address associated with the IP packets is valid (i.e., within an allowable range of addresses).

Although the video encoder module 555 is shown in FIG. 5 as being included within the CPE device 130, in an alternative embodiment, the video encoder 555 may be separate from the CPE device 130. For example, the video encoder 555 may be co-located or integrated into a camcorder or audiovisual source such that the video encoder 555 provides the CPE device 130 with one or more IP packets that include the recorded audiovisual information from the camcorder or the audiovisual source.

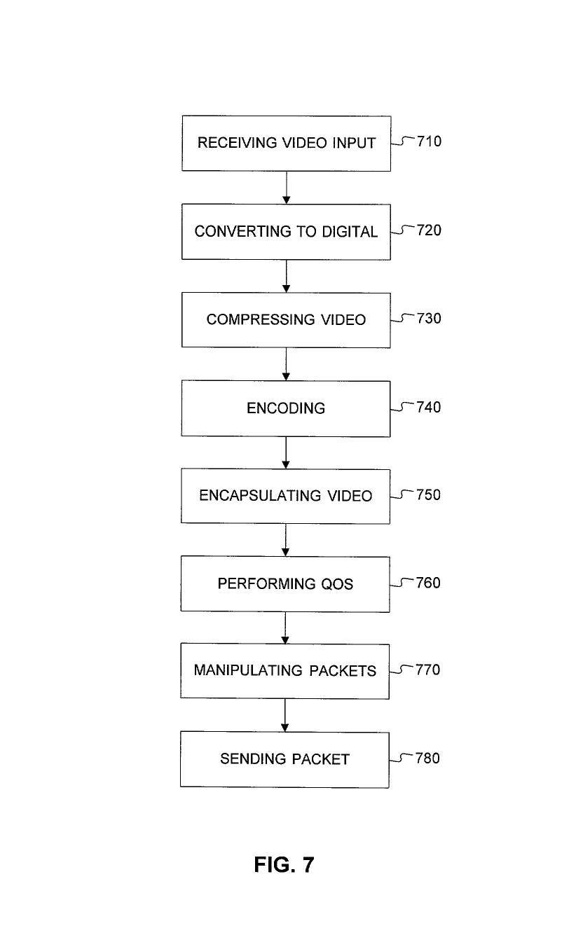

FIG. 7 shows exemplary steps for processing video information. Referring to FIG. 7, the video module 610 may receive video information (step 710), and, if necessary, convert video information to digital (step 720). In one embodiment, the video module may further manipulate and process the received video information in accordance with a predetermined protocol. The MPEG module 615 may receive the digital video information from the video module 610 and compress the digital video using an MPEG-n compatible format, such as MPEG-4 (step 730). The Reed Solomon module 620 may then encode the compressed digital video (step 740) to provide forward error correction and error detection.

The IP controller 630 may encapsulate the digital video information provided by the Reed Solomon module 620 within packets (step 750), such as IP packets.

The serial data module 691 may receive quality of service information from the access device (e.g., the access device 120 of FIG. 1) and provide the quality of service information to the CPU 460. As noted above, the CPU 460 may use the received quality of service information to vary one or more parameters of the MPEG module 615, such as varying the compression ration (step 760). Moreover, the CPU 460 may use the received quality of service information to vary one or more parameters of the Reed Solomon module 620, such as varying the run length (step 760). In one embodiment, step 760 may be performed whenever quality of service information is received by the serial data module 691. Although FIG. 6, shows a serial data module 691, a data module capable of receiving parallel data may be used instead.

The IP packets containing video information may be further manipulated by the Ethernet interface 640 by encapsulating the IP packets in a format for transport, such as encapsulating the IP packets within Ethernet (step 770). Furthermore, the Ethernet interface 640 may then send the Ethernet encapsulated IP packets to the access device 120 through the switch 470, the bus 490, the VDSL modem 410, the splitter 590, and the twisted-pair 591 (step 780).

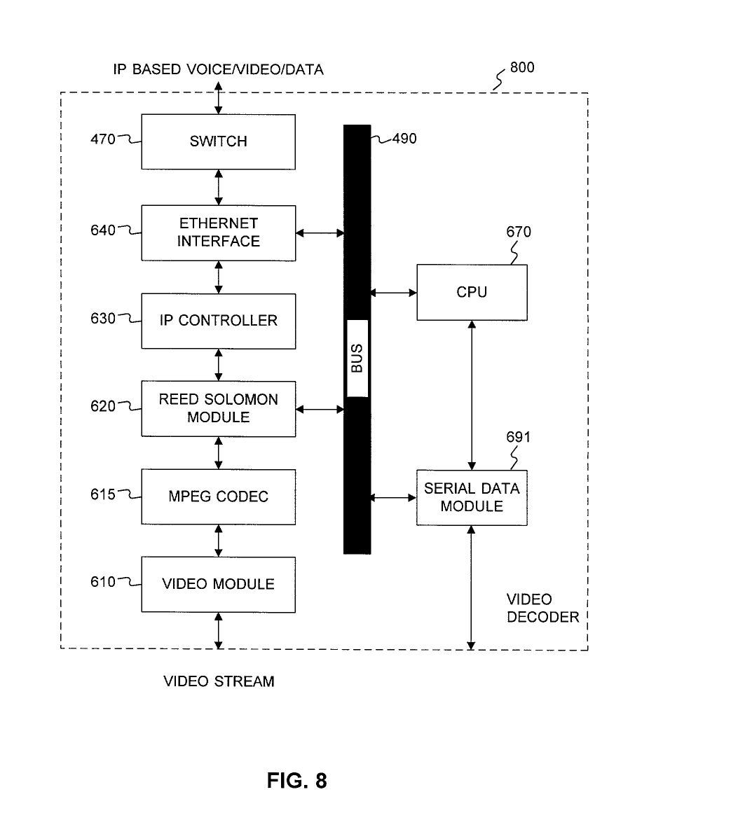

FIG. 8 shows a decoder module 800 that may be implemented within the MPEG codec module 575 for coding and decoding audiovisual information. Alternatively, the decoder module 800 may be implemented as a stand-alone module that only decodes audiovisual information. The decoder module 800 may include a switch 470, an Ethernet interface 640, an IP controller 630, a Reed Solomon module 620, an MPEG module 615, a video module 610, a CPU 670, a bus 490, and a serial data module 691.

In one embodiment, the MPEG codec module 575 may include a video codec capable of interfacing to one or more types of video sources. Moreover, when a browser is included in the CPU 670, a television (not shown), connected to the CPE device 130, may function as an Internet access device receiving audiovisual information from the Internet through the MPEG codec 575 and displaying such information on the television. In this embodiment, the video encoder 555 may be used to support video teleconferencing.

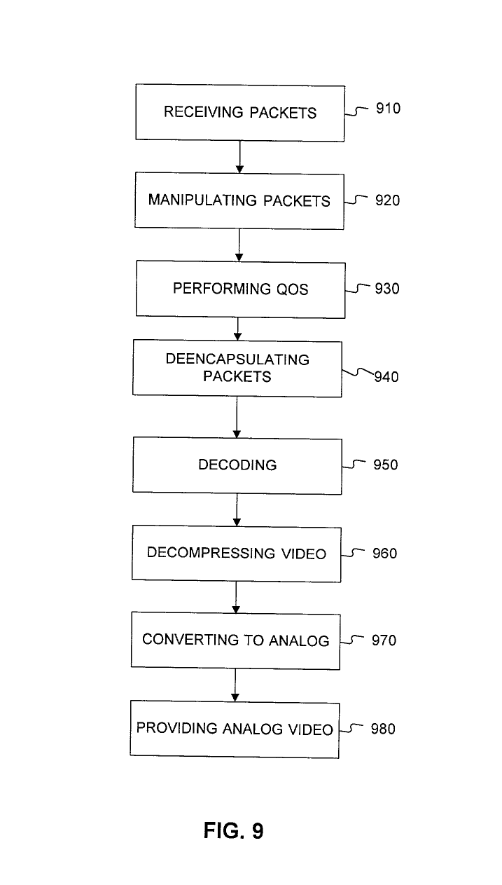

FIG. 9 shows an exemplary flowchart depicting steps for processing packets with audiovisual information using, for example, the decoder module 800. The decoder module 800 may receive packets at the switch 470 (step 910) from the access device 120 through the twisted-pair 591, splitter 590, VDSL modem 410, and bus 490.

To manipulate packets (step 920), Ethernet interface 640 may remove the Ethernet protocol that encapsulates the IP packets.

To perform quality of service (step 930), the CPU 670 may receive instructions to measure one or more quality of service parameters including, for example, availability, throughput, packet loss, latency, and jitter. Moreover, the serial data module 691 may receive and forward to the CPU 670 one or more parameters used during the step of compressing (step 730) and/or the step of encoding (step 740) to decompress and decode. For example, the CPU 670 may configure the MPEG codec 615 and Reed Solomon module 620 to decompress (step 960) and decode (step 950) based on the corresponding compressing (step 730) and/or encoding (step 740) at the video encoder 555.

The IP controller may then remove one or more IP packet headers that encapsulate the audiovisual information (step 940).

To decode the audiovisual information (step 950), the Reed Solomon module 620 may decode the FEC and, if necessary, perform error detection and correction in the received audiovisual information. The Reed Solomon module 620 may provide the number of errors detected and/or corrected to the CPU 670 as a quality of service measurement(s).

To decompress the audiovisual information (step 960), the MPEG codec 615 may decode the audiovisual information by decompressing based on an MPEG-n format. The decompressed audiovisual information may then be processed into an analog (step 970) or digital output by the video module 610. The resulting video stream and, if present, audio stream may be provided (step 980) to a user device, such as a television, digital television, video teleconferencing device, and/or any other device capable of receiving an audio and/or visual stream of information.

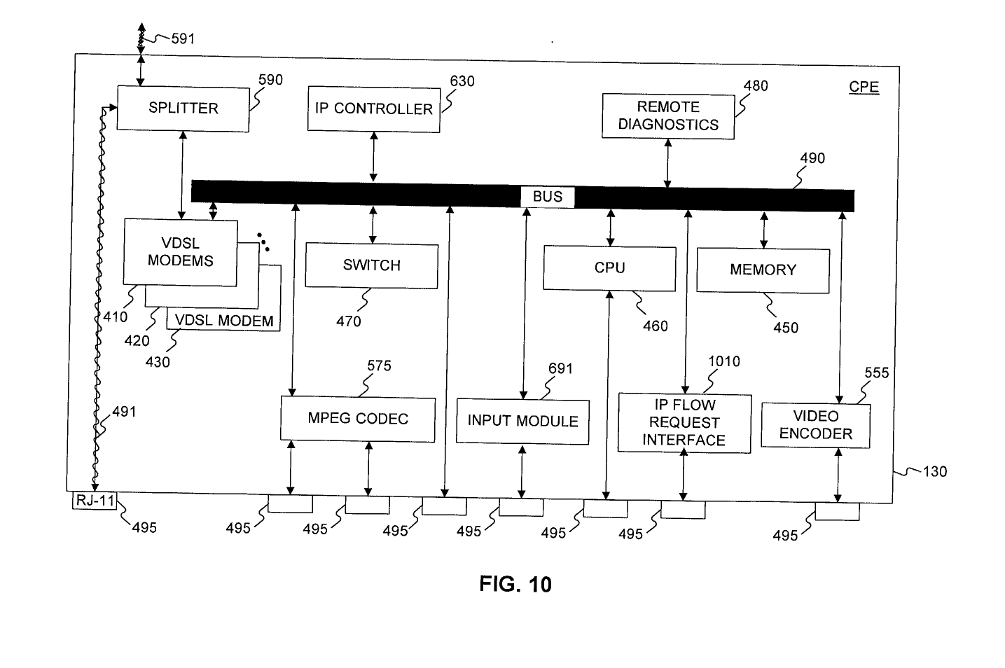

FIG. 10 shows an exemplary block diagram including an input module 691, an IP flow request interface 1010, a CPU 460, and an IP controller 630.

In one embodiment, an IP information flow request may be established using the input module 691 to receive an indication that an IP information flow has been selected. For example, the input module 691 may receive a selection from an infrared remote controller 137, an infrared keyboard 138, and/or any other device capable of selecting an IP information flow. The IP information flow request may select one or more IP flows such that each of the one or more IP information flows includes audiovisual information, such as Internet access, audiovisual entertainment, television, radio, cable television, and/or digital television.

The CPU 460 may include a browser that serves as an IP flow request interface 1010 for receiving the selection of an IP information flow. For example, the browser (not shown) may include one or more television channels, Internet sites, and/or other sources of information. Using, for example, an infrared remote controller 137, a user may make a selection from a list on the browser, which is displayed through the IP flow request interface on a television or computer (e.g., the television 136 or computer 134). This selection may then be received by the CPU 460 and the switch 470 through the input module 691. The CPU 460 and switch 470 may then proceed to establish one or more channels consisting of an IP information flow between a source of the audiovisual information and the CPE device. Alternatively, the CPU 460 and switch 470 may establish two unidirectional channels. That is, a first channel for IP packets flowing from the source of the audiovisual information to the CPE device and a second channel for packets flowing from the CPE device to the source of the audiovisual information. In one embodiment, the source of the audiovisual information and the CPE device may be connected to an access device that integrates the audiovisual information with other sources of information.

Moreover, the IP controller 630 may also ensure that the audiovisual information being provided to the user through the user's CPE device corresponds to the IP flow selected by the user. For example, the IP controller 630 may only permit IP packets corresponding to the selected source of the audiovisual information to pass to the user's end system that is connected to the CPE device (e.g., the computer 134, the video conferencing system 135, and/or the television 136).

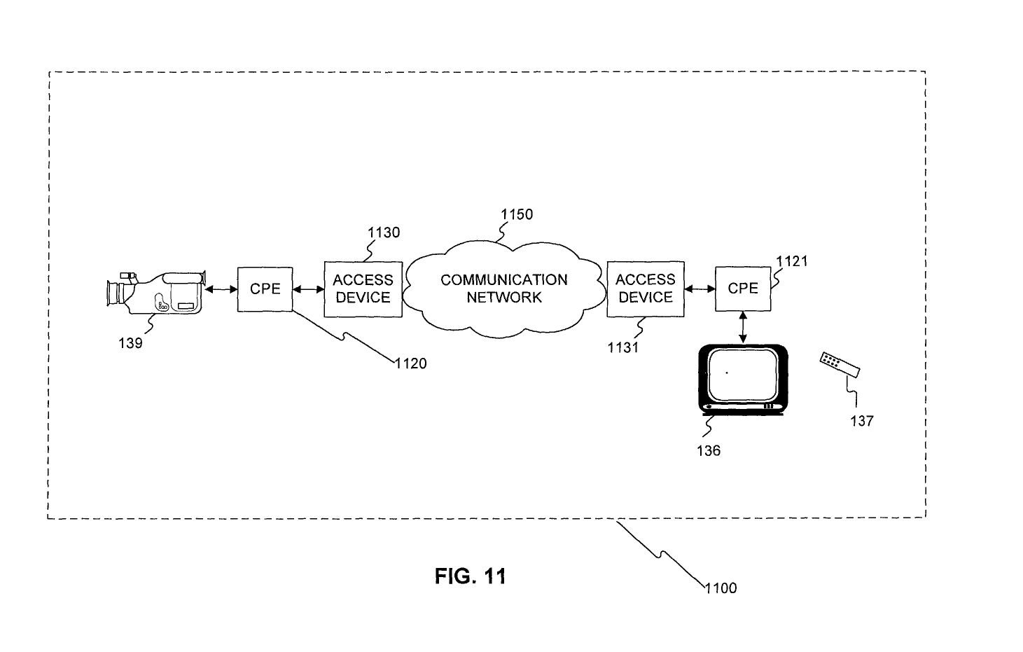

FIG. 11 shows a block diagram of a network consistent with the methods and systems of the present invention. FIG. 11 may include an audiovisual source 139, CPE devices 1120-1121, a communication network 1150, and access devices 1130-1131. Moreover, the audiovisual source 139, the CPE devices 1120-1121, the communication network 1150, the access devices 1130-1131, and the subsystems therein may function in a bi-directional manner, permitting a bi-directional flow of information (i.e., transmit and receive), or in a unidirectional manner instead.

A user of the television 136 may use IR remote 137 to make an IP information flow request that is received by the input module 691 of the CPE 1121. The IP information flow may correspond to audiovisual information, such as Internet access, audiovisual entertainment, television, radio, cable television, and/or digital television. The information flow may be bi-directional (i.e., with information flow in the transmit direction and the receive direction). In one embodiment, the CPE 1121 may use a browser (i.e., provided by the IP flow request interface 1010) that provides a monitor, such as the television monitor 136 with a display listing one or more possible sources of audiovisual information. The user may then select from the listing a source of audiovisual information using the IR remote 137. The user's selected source of audiovisual information may be then be received by the input module 691 (not shown) of CPE 1121. In one embodiment, the browser also provides Internet access to the user of the television 136.

The CPE 1121 may then proceed to establish an information flow, such as an IP packet flow between the selected source of the audiovisual information and the CPE device 1121. That is, the CPE device 1121 may proceed to establish one or more connections, such as transmission control protocol (TCP) connections to the selected source of the audiovisual information. The TCP connections permit an information flow, such as an IP packet flow between the selected source and the destination CPE device 1121. The CPE device 1121 may also process and then provide the audiovisual information to the television 136. In this example, the selected source of audiovisual information corresponds to the audiovisual source 139 that is co-located with the CPE device 1120. Moreover, although this example uses the TCP to establish connections, any other protocol, such as a UDP may be used instead. When the CPE device 1121 receives the IP packet flow from the audiovisual source 139 and CPE device 1120, the CPE device 1121 may use the decoder module 800 that receives packets and processes packets as described above with respect to FIGS. 8 and 9.

Moreover, a quality of service module 485 may measure the quality of service between the access device 1131 and the CPE device 1121. The quality of service module 485 may measure one or more parameters including, for example, availability, throughput, packet loss, latency, and jitter, and provide the measured one or more parameters to the access device 1130 and/or CPE device 1120 through the communications network 1150 to enable adapting the encoding of the source of audiovisual information based on the measured quality of service. For example, if the measured one or more parameters indicates a degraded quality of service, the CPE 1120 may vary the parameters of the video encoder 555 based on the measured quality of service.

In one embodiment, the CPE device 1120 may include a video encoder 555 as described above with respect to FIG. 6. The video encoder module 555 may receive the measured quality of service parameters at the serial data module 691. The serial data module may then provide the measured quality of service measurements to CPU 460. CPU 460 may be used to configure the video encoder 555, MPEG module 615, and/or Reed Solomon encoder 620 based on the measured quality of service parameters. In this embodiment, the CPU 460 may vary calculating the image vectors based on the measured quality of service measurements received by the serial data module 691, vary the configuration of the MPEG module 615, and/or vary the encoding scheme used for audio (e.g., changing from 8-bit PCM voice coding to CELP coding). Moreover, the CPU 460 may also send the varied configuration and/or encoding scheme to the CPU 670 in the video decoder 800, which permits the decoder to properly decode the encoded audiovisual information.

In one embodiment, the access devices 1130, 1131, and CPE devices 1120, 1121 support prioritization of the information flows, such as prioritization of the IP packet flows. For example, eight priority levels may be established to prioritize the types of information flowing through the network 1100. The CPE device 1121 may be configured to assign the highest priority to an RJ-11 port 495 supporting video conferencing, a port supporting audiovisual information that includes digital television may be assigned the second highest priority, a port supporting VolP may be assigned the third highest priority, a port supporting facsimile services may be assigned the fourth highest priority, and other ports may be assigned lower priorities such as establishing the lowest priority for file transfers and e-mail. Other priority schemes are possible and may be configured by a user of the CPE device 1121 or by the access device 1131. Alternatively, the priority scheme may be pre-configured in the CPE device 1121 during boot-up.

In one embodiment, each packet is tagged with Multi Protocol Label Switching (MPLS) that identifies the packet as belonging to one of the above priority levels. The access devices 1130, 1131 and CPE devices 1120,1121 may support MPLS. Moreover, the communications devices that transport the packets in the communication network 1150 may also support MPLS. For example, the CPE device 1121 may use the resource reservation protocol (RSVP) to request a certain bit rate when creating a connection, such as a TCP/IP connection with the source CPE device 1120 and/or the source of the audiovisual information 139. If the connection request is approved at the requested bit rate, the packets may be transmitted at that requested bit rate. Alternatively, the communications devices between the source of the audiovisual information 139 and the destination CPE 1121 (i.e., CPE 1120, access device 1130, access device 1131, etc.) may deny the request and send a message to the CPE device 1121 indicating that the requested bit rate cannot be satisfied. If that is the case, the CPE device 1121 may wait until the requested bit rate is available or make another request at a lower bit rate.

When the RSVP protocol guarantees a bit rate from the CPE device 1121 to the source of the audiovisual information 139, the source of audiovisual information 139 may begin transmitting at that bit rate. The CPU (not shown) within the source CPE device 1120 may then configure the MPEG encoder (not shown) and Reed Solomon encoder (not shown) to output at the guaranteed bit rate and quality of service based on the MPLS tag that corresponds to the type of information.

The quality of service module 485 at the destination access device 1131 may monitor various quality of service parameters between the access device 1131 and the CPE device 1121. When at least one of the quality of service parameters suggests that the quality of service is deteriorating (e.g., the rate of lost packets exceeds a threshold), the quality of service module 485 of access device 1131 may then send a control message to the video encoder 555 at the source CPE device 1120 to vary the configuration of the video encoder 555 such that a lower bit rate is output by the video encoder 555, which may result in fewer lost packets. In the case of VolP packets, the voice codec may change the type of voice codec used, such as changing from 8-bit PCM voice coding to CELP or any other type of voice compression/decompression codec.

The above embodiments and other aspects and principles of the present invention may be implemented in various environments. Such environments and related applications may be specially constructed for performing the various processes and operations of the invention or they may include a general-purpose computer or computing platform selectively activated or reconfigured by program code (also referred to as code) to provide the necessary functionality. The processes disclosed herein are not inherently related to any particular computer or other apparatus, and may be implemented by a suitable combination of hardware, software, and/or firmware. For example, various general-purpose machines may be used with programs written in accordance with teachings of the present invention, or it may be more convenient to construct a specialized apparatus or system to perform the required methods and techniques.

The present invention also relates to computer readable media that include program instruction or program code for performing various computer-implemented operations based on the methods and processes of the invention. The media and program instructions may be those specially designed and constructed for the purposes of the invention, or they may be of the kind well-known and available to those having skill in the computer software arts. Examples of program instructions include for example micro-code, machine code, such as produced by a compiler, and files containing a high-level code that can be executed by the computer using an interpreter.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for encoding a signal, said method comprising:
encoding the signal;
receiving at least one of a plurality of quality of service measurements;
compressing the signal to produce a packet flow; and
varying said compressing step based on at least one of the plurality of quality of service measurements, wherein an amount of information transferred by the packet flow varies to maintain a predetermined quality of service associated with the packet flow between the source of the packet flow and the destination of the packet flow.

2. The method of claim 1, further comprising:
defining the signal as a digital signal.

3. The method of claim 1, further comprising:
establishing the packet flow to a destination, wherein the packet flow includes an address identifying the packet flow.

4. The method of claim 1, further comprising the step of:
defining the address as an Internet Protocol address.

5. The method of claim 1, further comprising the step of:
receiving the signal from a source of information.

6. The method of claim 1, further comprising the step of:
encoding the signal with a Reed-Solomon encoder.

7. The method of claim 1, further comprising the step of:
defining the plurality of quality of service measurements to include one or more of the following: availability, throughput, packet loss, latency, and jitter.

8. The method of claim 2, further comprising the step of:
defining the digital signal as a video signal.

9. The method of claim 2, further comprising the step of:
defining the digital signal as an audio signal.

10. A system for encoding a signal, said system comprising:
means for encoding the signal;
means for receiving at least one of a plurality of quality of service measurements;
means for compressing the signal to produce a packet flow; and
means for varying said means for compressing based on at least one of the plurality of quality of service measurements, wherein an amount of information transferred by the packet flow varies to maintain a predetermined quality of service associated with the packet flow between the source of the packet flow and the destination of the packet flow.

11. A system for encoding a signal, said system comprising:
code that encodes the signal,
code that receives at least one of a plurality of quality of service measurements,
code that compresses the signal to produce a packet flow, and
code that varies said code that compresses based on at least one of the plurality of quality of service measurements, wherein an amount of information transferred by the packet flow varies to maintain a predetermined quality of service associated with the packet flow between the source of the packet flow and the destination of the packet flow; and
at least one processor that executes said code.

12. A method for decoding a signal, said method comprising:
decoding the signal;
receiving at least one of a plurality of quality of service measurements;
decompressing the signal to produce an information flow; and
varying said decompressing step based on at least one of the plurality of quality of service measurements, wherein an amount of information transferred by the information flow varies to maintain a predetermined quality of service associated with the information flow between the source of the information flow and the destination of the information flow.

13. The method of claim 12, wherein said step of decompressing further comprises the step of:
decompressing the signal to produce a packet flow.

14. A system for decoding a signal, said system comprising:
code that decodes the signal,
code that receives at least one of a plurality of quality of service measurements,
code that decompresses the signal to produce an information flow, and
code that varies said decompressing based on at least one of the plurality of quality of service measurements, wherein an amount of information transferred by the information flow varies to maintain a predetermined quality of service associated with the information flow between the source of the information flow and the destination of the information flow; and
at least one processor that executes said code.

15. A system for decoding a signal, said system comprising:
means for decoding the signal;
means for receiving at least one of a plurality of quality of service measurements;
means for decompressing the signal to produce an information flow; and
means for varying said decompressing based on at least one of the plurality of quality of service measurements, wherein an amount of information transferred by the information flow varies to maintain a predetermined quality of service associated with the information flow between the source of the information flow and the destination of the information flow.
